(19) United States
(12) Patent Application Publication
(10) Pub. No.: US 2012/0281294 A1
(43) Pub. Date: Nov. 8, 2012

(54) SECURITY ELEMENT COMPRISING AN ADHESIVE AND A SUBSTRATE BEARING AN OPTICAL STRUCTURE, AND ASSOCIATED METHOD

(75) Inventors: Michel Camus, Rives Sur Fure (FR); Stéphane Mallol, Provins (FR); Pierre Doublet, Saint Brice (FR)

(73) Assignee: Arjowiggins Security, boulogne Billancourt (FR)

(21) Appl. No.: 13/505,092

(22) PCT Filed: Oct. 28, 2010
(86) PCT No.: PCT/IB2010/054896

§ 371 Date: Jul. 20, 2012

(30) Foreign Application Priority Data
Oct. 30, 2009 (FR) 09 57714

(51) Int. Cl. G02B 27/12

(52) U.S. Cl. 359/619

(57) ABSTRACT

The invention relates to a security element (1) which comprises a substrate (6) bearing at least the following elements on at least one of the faces thereof, namely: an optical structure (4) producing at least one image of at least one pattern (5) and/or producing image points of a light source illuminating the optical structure; and an adhesive (14), in particular a heat-sealable varnish, covering at least part of the aforementioned face of the substrate (6) without fully covering the optical structure (4).

The present invention relates to security elements, notably those intended to be introduced into security documents.

The term “security document” is used to mean a payment means, such as a bank slip, a check or a restaurant ticket, an identity document, such as an identity card, a visa, a passport or a driving license, a lottery ticket, a transport pass or even a ticket for entry to cultural or sporting events.

In order to safeguard against attempts to falsify or counterfeit a security document, it may be useful for the authentication and/or the identification of a security element to be able to be done simply.

It is known practice to produce security elements with lens arrays associated with specific prints, in order to produce movement, depth and/or stereoscopic effects. The company SECURENCY markets these under the trade name MOTION®.

Such security elements exploit an optical structure, one face of which is exposed to the air, in order for the difference between the refractive indices of the air and of the material of the structure to produce the desired refraction of the light rays.

The optical effects obtained by using lens arrays have been notably described in the article “The History of Integral Print Methods”, taken from “Lens Array Print Techniques” by David E. Roberts and Trebor Smith, the article “The moiré magnifier” by M C HUTLEY et al., 1994 IOP Publishing Ltd., and the “Academy of the Sciences” publication, from the session of 2 Mar. 1908.

Also known from the publications U.S. Pat. No. 3,241,429, U.S. Pat. No. 3,154,872, U.S. Pat. No. 3,576,089, U.S. Pat. No. 4,645,301, U.S. Pat. No. 4,892,336, U.S. Pat. No. 6,833,960, WO 94/27254, WO 2005/052650, U.S. Pat. No. 6,856,462, US 2005/184 504, U.S. Pat. No. 5,708,871, WO 2005/058610, US 2005/150964, US 2009/008923, WO 2007/020048, and WO 2009/017824 are various optical structures.

Lens arrays have been used in the prior art to enable them to be superposed on printed patterns so as to generate effects of movement in observation, notably by enlarging moiré effects.

U.S. Pat. No. 7,497,475 and WO 2007/133613 describe security documents that include optical structures, on which prints are directly produced.

Also known from the publications WO 2005/052249, JP 2008-063685, JP 2008-063684, EP 1 704 537, EP 1 567 713, EP 1 442 171, GB 2 311 303, U.S. Pat. No. 5,783,275, EP 1 141 480, EP 1 872 965, EP 1 887 134, EP 0 319 157, EP 2 082 097, WO 96/39685, U.S. Pat. No. 5,405,500, EP 0 609 252 and EP 0 059056 are methods for incorporating security elements in security documents, comprising an adhesive to facilitate their incorporation.

The application of an adhesive to optical structures of a security element may, however, present the drawback of damaging the observation properties of the optical structures because of the presence of the adhesive on their surface.

There is a need for security elements with an optical structure that can be effectively incorporated in a security document while retaining the visual properties of the optical structure.

Thus, the subject of the invention, according to one of its aspects, is a security element comprising a substrate bearing, on at least one of its faces, at least:
one optical structure, notably an optical structure producing at least one image of at least one pattern and/or producing image points of a light source illuminating the optical structure,
an adhesive, in particular a heat-sealable varnish, at least partially covering said face of the substrate without completely covering the optical structure.

The optical structure may totally cover the face of the substrate bearing the optical structure, or, as a variant, cover it only partially.

The abovementioned pattern can be used to generate at least one image which can be compared to a reference pattern in the context of an authentication for example. This pattern is hereinafter called comparison pattern, even if its role is purely decorative and/or game-oriented.

The expression “without completely covering” should be understood to mean not covering all the optical structure or covering it but not entirely.

The absence of adhesive completely covering the optical structure may make it possible to not affect the observation properties of the optical structure in the part or parts not covered by the adhesive.

The adhesive may make it possible to improve the adhesion of the security element to a security document.

The adhesive may totally cover the area or areas of the face of the substrate not covered by the optical structure when said optical structure only partially covers the face of the substrate bearing it.

The adhesive may at least partially cover the two faces of the substrate. The two faces of the substrate may or may not each bear an optical structure. The adhesive may totally cover one face of the substrate without any optical structure.

The adhesive may be transparent, translucent or opaque. The adhesive may be heat-sealable. The adhesive may be uncolored or colored, visible to the naked eye, under ultraviolet (UV) and/or infrared (IR) light, fluorescent, phosphorescent, thermochromic, photochromic, to name just a few of the options.

The adhesive arranged on one face may be colored, and associated with a substrate or with a second adhesive arranged on the other face that has another coloring. In particular, when the adhesive on the one hand and the substrate or the second adhesive on the other hand have different fluorescent colorings, an effect similar to that described in the application FR 2 877 609 is obtained.

The adhesive may form a pattern that corresponds to, for example is identical to, or complements the comparison pattern and/or the reference pattern. Said adhesive is in particular visible under UV and/or IR illumination, fluorescent or phosphorescent.

The adhesive may, for example, be a heat-sealable coating, for example a heat-sealable varnish, an ultraviolet (UV) cross-linkable agent, an adhesive to be irradiated, a pressure-sensitive adhesive (PSA), a varnish with a solvent base, of polyester type for example, an adhesive in aqueous phase, etc.

Among the adhesives in aqueous phase that can be used, the following brands can in particular be cited: Mowilith DC (aqueous dispersion of homopolymer vinyl acetate with particles with a size ranging from 0.3 μm to 2 μm and a glass transition temperature T_{g} of approximately 38° C., and dry solids content of between 55 and 57%) and Vinamul 3265 from the company CELANESE; DH9004, DH9017, DH9044 and DL5001 from the company COLLANO; Primal NW1845, Primal LC40, Primal P308M and Primal EP6000 from the company ROHM & HAAS; 006SDW078-2 from the company BASF.

The adhesive may advantageously be a polyvinyl acetate-based adhesive such as Mowilith DC.

The incorporation of the adhesive in the security element can be done by coating or printing.

The coating can be produced before or after formation of the optical structure on the substrate.

The coating can be produced on a single face of the substrate or on both faces of the substrate. The adhesive may entirely cover one face of the substrate.

The adhesive may cover a reference pattern borne by one of the faces of the substrate, notably the face bearing the optical structure.

### Optical Structure

The optical structure may have a non-planar external surface, that is to say facing the observer.

The optical structure may or may not extend from one edge to the other of the substrate depending on the length and/or the width of the substrate.

The substrate may have one or more areas without the optical structure and one or more areas covered by the optical structure.

The optical structure may be discontinuous. In particular, the optical structure may consist of a set of unconnected optical substructures, identical or not. These optical substructures may comprise individual optical structures, for example lens arrays, these individual optical structures being able to be connected or unconnected, and to be identical or non-identical.

The adhesive may cover in particular the area or areas of the face of the substrate not covered by the individual optical structures.

The optical structure may be reflecting or not. As a variant, it may be partially reflecting, for example semi-reflecting.

The optical structure may have an elongate form along a longitudinal axis.

The optical structure may have any geometrical form, for example polygonal or not in outline, for example square, rectangular, rhomboid, triangular, trapezoid, parallelogram, circular, elliptical, or other.

The individual optical structures forming the optical structure may or may not all have the same geometrical form. The individual optical structures may, for example, all be in the form of parallelograms. The individual optical structures, identical or not, may be arranged on the security element at regular or non-regular intervals.

The optical structure may comprise a lens array with a thickness, for example, of between 2 and 30 μm, for example equal to 6 μm, and a lens diameter, for example, of between 10 and 100 μm, for example equal to 20 μm.

The optical structure may have a surface, reflecting or not, of at least partially spherical form, possibly truncated, polyhedral, notably pyramidal, with a possibility of truncated apex, among others. The optical structure may also include a Fresnel lens.

The optical structure may be produced by embossing, notably by heat-embossing or by embossing followed by ultraviolet cross-linking, or by molding. The optical structure may even include a printed lens array comprising lenses that are juxtaposed or not, for example by UV printing, for example by screen printing, photogravure, typography, or even by inkjet printing.

The optical structure may be produced by screen printing, photogravure, flexography and offset printing.

The optical structure may comprise a concave, convex or Fresnel lens, a lens array or even a resin or varnish print, for example cross-linkable by ultraviolet rays.

In the case of a reflecting optical structure, the optical structure may consist of individual optical structures in the form of mirrors arranged in a regular array, in one or more directions.

In the case of a reflecting optical structure, the reflecting surface of the optical structure may be produced by a metalization of a non-planar surface, which makes it possible to benefit from a continuous reflecting surface whereas the embossing of a film of a transparent substrate covered on one face with a layer of metal would be likely to break the surface of the metal and lead to the formation of non-esthetic cracks and/or potentially rendering the optical structure partially inoperative.

The abovementioned mirrors may notably be formed by the metalization of a lens array, a non-planar face of the array preferentially being metalized after the fabrication of this array, to avoid breaking the layer of metal, as explained above. The mirror(s) may be of different types, for example concave, convex, cylindrical, parabolic, spherical or aspherical. In the array, all the mirrors may or may not be identical.

The at least partially reflecting optical structures may also be obtained by producing a Fresnel lens receiving a metalization.

In some exemplary implementations of the invention, the at least partially reflecting optical structure(s) is/are concave toward one or more patterns formed on the substrate in order to produce at least one enlarged image of the pattern(s), and make it possible to observe the pattern(s) more easily, despite their small size.

The optical structure, for example the abovementioned lens array, may be formed on the substrate, in the same material or not, by being added on or not. The lens optical structure may be produced, for example, by printing or embossing.

The thickness of the substrate is, for example, between 5 and 100 μm, preferably 20 and 30 μm. The substrate may have a constant thickness. The thickness of the substrate may possibly be chosen according to the optical structure, for example according to the focal distance of this optical structure, so as to have the desired optical effect.

The abovementioned optical structure may be produced in such a way that the associated comparison pattern is located between the substrate and the optical structure. In this case, the thickness of the substrate may not substantially modify the visual rendering obtained.

The optical structure may cover one face of the substrate and the comparison pattern(s) may be formed thereon on the opposite face. In this case, the choice of the thickness of the substrate makes it possible to bring the comparison pattern closer to or take it more distant from the optical structure, and may make it possible to adapt the distance from the comparison pattern to the optical structure according to the focal distance thereof.

The lens array may comprise an array of spherical mirrors, for example concave toward the substrate. In exemplary implementations of the invention, the radius of the apex of a mirror, notably when the latter is concave toward a pattern formed on the substrate, may be between 30 and 45 μm. The distance between the apex of the mirror and the adjacent face of the substrate is, for example, between 10 and 20 μm, with a value, for example, of between 14 and 16 μm. The pattern associated with the mirror may be entirely situated in the concavity of the mirror. The diameter of the mirror, at the level of its face adjacent to the substrate, is, for example, between 50 and 70 μm, with a value, for example, of between 58 and 62 μm.

The abovementioned optical structure may be metalized by a vacuum metalization technique, the metal used being, for example, aluminum.

The security element may comprise optical structures of different types.

The optical structure may comprise non-planar individual reflecting surfaces, for example concave or convex, a small dimension of which, notably the height, is for example, greater than or equal to 20 μm, for example 30 μm.

The optical structure may be covered, preferably partially, by at least one optical structure inactivation varnish, canceling the optical effect or effects obtained by the optical structure. This inactivation varnish has, for example, a refractive index equal to or sufficiently close to that of the optical structure for the optical structure to cease producing its effects. The inactivation varnish may be transparent, colored or not.

The presence of an inactivation varnish on the optical structure can thus make it possible to create one or more areas without optical effect on the optical structure, making it possible to see, where appropriate, a pattern underlying the optical structure, with no enlargement effect by the optical structure.

The inactivation varnish may be superposed on a reference pattern borne by the substrate, for example borne by the face of the substrate opposite the face bearing the optical structure. In this way, the presence of the inactivation varnish canceling the optical effect or effects of the optical structure may make it possible to observe the reference pattern through the optical structure without this observation being affected by the optical structure. The observation of the reference pattern through the optical structure covered with such an inactivation varnish may notably correspond to the observation of the reference pattern which would be done directly without the presence of the optical structure.

The inactivation varnish may have a refractive index which is, for example, greater than that of air. The refractive index of the inactivation varnish may, for example, be the same as the refractive index of the optical structure, notably of the area of the optical structure onto which the inactivation varnish is applied. The refractive index of the inactivation varnish may, generally, be chosen such that it makes it possible to cancel the optical effect or effects obtained by the optical structure.

The inactivation varnish may, for example, be applied to the optical structure by a printing method.

The external surface of the inactivation varnish may be adapted to cancel the optical effect or effects obtained by the optical structure. It may preferably be planar.

The inactivation varnish and the heat-sealable varnish may form only one and the same varnish.

As a variant, the security element comprises heat-sealable varnish and inactivation varnish present in distinct forms. The inactivation varnish may then be arranged between the security element and the heat-sealable varnish.

The optical structure may totally cover the face of the substrate which bears it and comprise an inactivation varnish canceling, in places, the optical effect or effects of this optical structure. In this way, the method for manufacturing the security element may be simplified. For example, from a substrate bearing on at least one of its faces an optical structure totally covering said face, the manufacturing method may comprise the step consisting in forming one or more reference and/or comparison patterns, notably by printing, on the substrate and in applying an optical structure inactivation varnish onto the substrate, notably on a face of the substrate opposite the face bearing the reference and/or comparison pattern(s), the reference and/or comparison patterns and the inactivation varnish being applied in a localized manner.

The use of an inactivation varnish as described previously may notably be done when the optical structure has one or more optical effects originating from the non-planarity between the ambient air and the optical structure, notably when the optical structure comprises a lens array.

The inactivation varnish of the optical structure may be partially or totally covered by an adhesive as described previously, notably a heat-sealable varnish.

The adhesive as mentioned previously may, as appropriate, be an inactivation varnish, canceling the optical effect or effects obtained by the optical structure.

### Pattern(s)

The substrate may bear at least one reference pattern, the optical structure and the reference pattern being borne by the substrate to allow for the simultaneous observation of at least one image given by the optical structure and the reference pattern.

One of the images given by the optical structure may substantially correspond to the reference pattern.

The expression “substantially corresponding” should be understood notably to mean that the simultaneous observation of the optical structure and of the reference pattern makes it possible to appreciate a resemblance between the observed images or a complementarity. In particular, at least one of the images given by the optical structure and the reference pattern may resemble one another, complement one another or be at least partially, better totally, superposed, corresponding, for example, to one and the same alphanumeric character, sign, logo, symbol, personage or object. In the case of a complementarity, at least one of the images of the comparison pattern produced by the optical structure may be the symbol of a currency whereas the reference pattern will be the numeric amount corresponding to the security document.

The invention may thus make it possible to authenticate and/or identify, in a simplified manner, an object, notably a security document, comprising a security element as described above, notably by the observation of similarities existing in the observation between at least one of the images given by the optical structure and the reference pattern.

Furthermore, the invention may make it possible to obtain a security element that is simple to manufacture, since it can easily be incorporated in a security document, by furnishing one and the same substrate with a reference pattern and an optical structure, the latter being able, where appropriate, to be superposed on a comparison pattern borne by the substrate.

The reference pattern may give an image that is fixed, in particular regardless of the angle of observation.

The reference pattern and/or the comparison pattern may consist of at least two individual patterns, respectively reference and/or comparison.

The reference pattern may be observed independently of the optical structure. It may in particular be situated outside the area comprising said optical structure.

The substrate may bear at least one comparison pattern, the optical structure being superposed on this comparison pattern.

The optical structure may produce at least one enlarged or non-enlarged image of the comparison pattern. The enlargement may, for example, be greater than 1.5, better 2, better 3, for example between 1.5 and 5. The strong enlargements will be used in particular in the case where the pattern, or the individual patterns, associated with the optical structure, are of very small dimensions. The strong enlargements will, for example, be obtained by enlarging moiré effect, as described in the literature mentioned previously.

The optical structure may give a moving image, notably an image whose dimensions are variable, an image that appears and disappears, or more generally a changing image, of one or more patterns according to the angle of observation. In the case of a movement effect, the amplitude of the movement will be all the greater when the enlargement ratio is high. At least one of the images of the comparison pattern may correspond, for example substantially, to the reference pattern, so that a user can observe both the reference pattern independently of the angle of observation and a moving image for the comparison pattern according to the angle of observation.

The comparison pattern may be arranged, notably relative to the optical structure, to allow for the observation of at least one 2D or 3D image.

The comparison pattern may notably use the enlarging moiré principle to obtain an effect of depth or an impression of movement. It may also comprise at least one image produced by the interleaving of at least two images, for example to obtain, upon a change of the angle of observation, an animation or a movement effect.

The optical structure and the comparison patterns may be configured notably positioned relative to one another so as to create an enlarging moiré effect or an animation effect provoked by the observation of at least two different images upon a change of the angle of observation. The animation effect may be obtained with a comparison pattern formed by the interleaving of said at least two different images.

At least two comparison patterns, possibly consisting of a number of individual patterns, may be situated at different distances from the optical structure, and in particular from the focus of a lens of the optical structure, in such a way that the images of these comparison patterns through the optical structure each appear in different planes, notably in planes situated at different depths.

For example, it is possible to form, notably by printing, on a comparison pattern, possibly consisting of a number of individual comparison patterns, or on the face of the substrate opposite the face bearing the comparison pattern, a secondary comparison pattern, notably a different size. In the case of a secondary comparison pattern formed on the face of the substrate opposite the face bearing the comparison pattern, the secondary comparison pattern may or may not be superposed on the comparison pattern. Because of this, at least one of the images of the comparison pattern and the image of the secondary comparison pattern may be observed in different planes.

An additional pattern may be formed, notably by printing, on the face of the substrate opposite the face bearing the comparison pattern or on a number of comparison patterns or even on a comparison pattern consisting of a number of individual comparison patterns. The dimensions of the additional pattern may be chosen in such a way that only the comparison patterns or the individual comparison patterns are affected by the optical structure, the additional pattern forming a background on which the image of the comparison patterns or of the individual comparison patterns is observed through the optical structure.

At least one of the images of the comparison pattern may possibly be observable only under predefined lighting, for example ultraviolet and/or infrared.

The reference and comparison patterns, and/or the observed images of these patterns, may be of the same color or not, of the same orientation or not.

The reference and comparison patterns may be of different sizes and/or colors, and the observed images of these patterns may be of the same size and/or of the same color, or vice versa.

The reference pattern and/or the comparison pattern may have a surface with a dimension of between 10 and 60 mm², for example of the order of 40 mm².

The reference and comparison patterns, and/or the observed images of these patterns, may be of forms and/or dimensions, notably of size, that are similar or even identical.

The dimensions of the comparison and reference patterns may be identical or of the same order of magnitude. As a variant, the scale between the reference and comparison patterns may be variable. For example, the comparison pattern, respectively the reference pattern, may have a size of between 0.5 and 3 times the size of the reference pattern, respectively of the comparison pattern.

When the reference and comparison patterns are produced with different sizes, the optical structure may be produced to modify the apparent size of the comparison pattern in order for the apparent size of the comparison pattern as observed through the optical structure to be almost equal to that of the reference pattern. The apparent size of the comparison pattern observed through the optical structure may even have a size of between 0.5 and 3 times the size of the reference pattern.

As an example, a reference pattern of 5 mm² and a comparison pattern of 1.25 mm² with a targeted enlargement of 3 make it possible to obtain one and the same observed appearance despite a comparison pattern with surface area equal to 0.25 times that of the reference pattern.

Similarly, if the aim is to have an enlargement of 150 for the comparison pattern with the same reference pattern of 5 mm², the comparison pattern must have a surface area of 0.025 mm², or 0.005 times the size of the reference pattern.

The greatest dimension of the reference pattern may, for example, be between 1 and 3 mm.

The greatest dimension of the comparison pattern is preferably less than the greatest dimension of the reference pattern. The greatest dimension of the comparison pattern is, for example, between 0.1 and 0.3 mm.

The greatest dimension of at least one of the observed images of the comparison pattern may be substantially equal to the greatest dimension of the reference pattern, for example between 1 and 3 mm.

The security element may comprise a plurality of reference patterns and/or comparison patterns borne by one and the same face or not of the substrate, for example more than 2, better more than 3, better more than 4.

The security element, notably the substrate of the security element, may comprise an alternation of reference patterns and comparison patterns in at least one direction of a plane of the security element, making it possible, for example, to observe an alternation of fixed images and moving images.

The number of reference patterns may be identical or not to the number of comparison patterns.

The comparison pattern and/or the reference pattern may be formed on the substrate by metalization and/or demetalization, for example in aluminum. Metalizations and/or demetalizations are more difficult, even impossible, to reproduce by printing because of their thinness, which makes it possible to avoid counterfeiting by printing.

The comparison pattern and/or the reference pattern may be formed in positive or in negative on the substrate of the security element. In particular, all the comparison patterns and all the reference patterns may be formed in positive, or as a variant all in negative.

The comparison pattern and/or the reference pattern may be formed by printing. The reference pattern and/or the comparison pattern may be borne on the substrate of the security element for example by a printing method of the offset, copperplate engraving, laser, inkjet, micro-lithography, photogravure or screen printing type.

The reference pattern and/or the comparison pattern may be printed with inks that are colored or not, visible to the naked eye under ultraviolet (UV) and/or infrared (IR) light, opaque, fluorescent, phosphorescent, thermochromic, photochromic, translucent and/or transparent, among others.

The reference patterns may in particular be formed in positive by metalization of the substrate or in negative by demetalization of the substrate, and the comparison patterns may, for example, be prints produced on the substrate.

The reference and/or comparison patterns may be formed by offset, laser, inkjet or copperplate engraving printing, by flexography, by lithography (and micro-lithography), by photogravure and by screen printing.

The patterns comprise, for example, micropatterns produced by micro-lithography or by copperplate engraving printing.

The optical structure may focus the light into image points, the image given by the optical structure resulting from the focusing at the image points of at least one light source illuminating the optical structure. In this case, the substrate may bear only the reference pattern and the optical structure, notably being without any comparison pattern.

The optical structure, for example consisting of a number of individual optical structures, may have different sizes or forms, in order to produce image points of a light source at different distances, for example.

The light source illuminating the optical structure for the purposes of producing image points is, for example, the sun or an electric lamp, notably a source whose incident rays are parallel or substantially parallel.

The images given by the optical structure and a possible reference pattern may be observable in reflection and/or transmission mode. In the case where at least one of the images given by the optical structure results from the observation of image points of a light source, said image may be observed in reflection mode.

The substrate may or may not bear the optical structure and a reference pattern on one and the same face.

The substrate may or may not bear a comparison pattern on the face opposite the one bearing the optical structure.

Preferably, the substrate bears, on one of its faces, a reference pattern and a comparison pattern, and the optical structure on its opposite face.

The substrate may be at least partially transparent or translucent. The substrate may, for example, be or comprise a film of a transparent or non-transparent thermoplastic material, for example polyester or PET.

The security element may or may not extend from one edge to the other of an object incorporating it, notably a security document.

The security element may be a security thread, a security film or a patch.

Preferably, the security element is a security thread. The security element may have a width, for example, of greater than or equal to 4 mm, better 5 mm, even better 6 mm, for example between 6 and 8 mm, better between 6 and 10 mm.

The security element in the form of a security film or of a patch may, for example, be incorporated in a security leaf including an area of reduced thickness intended to receive the security element.

Advantageously, the width of the security element in the form of a security thread may enable the security element to include a reference pattern, an optical structure and possibly a comparison pattern of sufficient dimensions to allow for the easy observation thereof by the naked eye, while also making it possible to incorporate at least one other type of security element on the security thread, as described later, notably metalizations and/or demetalizations associated or not with magnetic elements.

In the case of production of the reference pattern by printing, it is possible to use, on the area of the reference pattern, transparent conductive inks, and/or produce the print of the reference patterns with a magnetic and/or conductive ink, for example of black color, for example based on carbon black.

In the case of a security element in the form of a security thread, the optical structure may extend only partially over the width of the security thread so that the substrate of the security thread has at least one edge area not covered by the optical structure. Such a security thread may, for example, be introduced into a window of an object.

The edge area may be metalized or not. The edge area may be not covered by a comparison pattern and/or a reference pattern and/or an optical structure. The edge area may be continuous or discontinuous.

The edge area may extend from one edge to the other of the security element, notably depending on the length of the security element.

The edge area, notably where it is without any optical structure, may be covered, at least partially, by an adhesive, notably a heat-sealable varnish. An edge area covered with such an adhesive may make it possible to reinforce the cohesion between the security element and an object in which it is incorporated. The security element is, for example, incorporated in a window formed in a fibrous base of the object with at least partial overlap between the edges of the window and the adhesive of the edge area. By virtue of this overlap, the fibers of the base of the object may be secured to the security element. It is thus possible to reinforce the cohesion between the security element and object, notably when the security element is arranged in a window, which may make it more difficult to extract the security element from the object without damaging the security element. It is thus possible to reduce the risk of a security element arranged in a window of a base of an object being removed from this object then reintroduced into another object.

The edge area may be covered with an adhesive over its entire length along the security thread, unlike what is described in the application US 2008/0182084.

The edge area may or may not include at least one magnetic or conductive element, notably in patch form. In this way, it is possible to confer electrical properties and magnetic properties on the security element.

The width of the edge area may, for example, be between 0.5 and 2 mm, for example 1.5 mm.

The width of the space between two edge areas, or between an edge area and an edge of the security element, is, for example, between 2 and 9 mm, for example between 3 and 6 mm.

The security element may advantageously comprise at least two edge areas in proximity to each of its edges, notably its edges along its length.

The security element may or may not be incorporated in window(s) in an object, notably a security document. When the security element is incorporated in window(s) in a security document, the window may advantageously make it possible to observe at least partially the optical structure, notably to allow for the simultaneous observation within the window of at least a part of the image given by the optical structure and of a reference pattern.

The security element may even be totally incorporated, notably by mass, or partially incorporated in an object, notably in a security document. The security element incorporated in an object may be totally or partially visible on just one of its faces or on both its faces.

The observation of the security element may or may not be done via a mask comprising an opening, the mask being placed on the security element in such a way that the opening makes it possible to simultaneously observe at least a part of a reference pattern and at least a part of the optical structure, for example in proximity to one another, notably juxtaposed with one another.

### Object

The invention also addresses an object, notably a security document, incorporating a security element as defined above. Such a security document may comprise a paper fibrous base and/or a synthetic base and the security element may have at least one visually accessible portion, for example extending in window(s) in this fibrous base.

The security element may be intended to be observed on just one face of the document, the mirror(s) or other individual optical structures being formed on the side of the substrate opposite the face facing the observer. As a variant, the security element may comprise, over a portion of its length, mirrors facing one of the faces of the substrate, and over another portion of its length, mirrors facing the opposite face of the substrate, so as to allow for the observation of one or more comparison patterns by reflection of their image on the reflecting surface of the corresponding mirror or mirrors, independently of the face from which the security element is observed. Other combinations of optical structures can be envisaged, notably the combination of spherical, concave and convex mirrors.

The metalization thickness defining the reflecting surface of the mirror may be sufficient to render the mirror opaque. As a variant, the thickness is sufficiently thin to confer a semi-reflecting nature on the mirror. Where appropriate, the layer of metal may include partial demetalizations, for example obtained by producing the metalization through a mask.

The reflecting effect may even be obtained by the application of a layer with high refractive index. In this case, the reflecting structure may not include any metalization. Layers with high refractive index are formed from compounds with high refractive index (HRI), for example such as zinc sulfide. These compounds are notably used to produce holograms.

The invention also relates, according to another of its aspects, to an object, notably a security document, comprising a paper fibrous base and at least one security thread incorporated in the fibrous base, the security thread comprising, before said incorporation in the object, a substrate bearing, on at least one of its faces, at least:
one optical structure, notably an optical structure producing at least one image of at least one pattern and/or producing image points of a light source illuminating the optical structure,
an adhesive, notably a heat-sealable varnish, at least partially covering said face of the substrate without completely covering the optical structure,
   the security thread having, when incorporated in the object, at least one visually accessible portion extending in window(s) in this fibrous base and edge areas of the substrate without any optical structure and covered by the adhesive.

### Other Security Elements

The security document, or the security element that it includes, may comprise one or more additional security elements as defined below.

Among the additional security elements, some can be detected by the eye, in daylight or in artificial light, without the use of a particular apparatus. These security elements comprise, for example, colored fibers or flakes, totally or partially printed or metalized threads. These security elements are called first level.

Other types of additional security elements are detectable only using a relatively simple apparatus, such as a lamp emitting in the ultraviolet (UV) or the infrared (IR). These security elements comprise, for example, fibers, flakes, strips, threads or particles. These security elements may or may not be visible to the naked eye, being, for example, luminescent under the illumination of a Wood lamp emitting in a wavelength of 365 nm. These security elements are called second level.

Other types of additional security elements require, for their detection, a more sophisticated detection apparatus. These security elements are, for example, capable of generating a specific signal when they are subjected, simultaneously or not, to one or more external excitation sources. The automatic detection of the signal makes it possible to authenticate, where appropriate, the document. These security elements comprise, for example, tracers in the form of active substances, particles or fibers, capable of generating a specific signal when these tracers are subjected to an optronic, electrical, magnetic or electromagnetic excitation. These security elements are called third level.

The additional security element(s) present in the security document, or in the security element which it includes, may have first, second or third level security characteristics.

The additional security element(s) may, for example, be included on one or more edge areas of the security element. For example, the security element may comprise, in a central area of the substrate, a reference pattern, an optical structure and, possibly, a comparison pattern, and, in one or more edge areas, one or more additional security elements as described above.

### Manufacturing Method

Another subject of the invention, according to another of its aspects, is a method for manufacturing a security element comprising a substrate, in which:
on at least one of the faces of the substrate, at least one optical structure is produced that only partially covers said face of the substrate, for example an array of individual optical structures, superposed, where appropriate, on at least one comparison pattern present on the substrate, and, possibly, at least one reference pattern is produced on said face of the substrate,
an adhesive, notably a heat-sealable varnish, is applied to the substrate, the adhesive at least partially covering said face of the substrate without completely covering the optical structure.

The optical structure may be formed, for example, by flexography, inkjet, offset or screen printing, for example with a dot of UV cross-linkable transparent polymer ink, or by hot embossing of a thermoplastic support with an etched metallic matrix in the form of a lens, among other possibilities.

The optical structure may or may not be formed on the same side of a substrate comprising a comparison pattern, with the localization or not of the basic optical structure relative to the comparison pattern. In case of localization, the comparison pattern is, for example, centered on the optical axis of the optical structure.

It is possible to produce a lens array comprising a plurality of identical lenses, which are metalized in order to form an array of non-planar mirrors.

### DESCRIPTION OF THE FIGURES

The invention will be able to be better understood from reading the following detailed description of nonlimiting exemplary implementations thereof, and from studying the appended drawing, in which:

FIG. 1 represents, in transversal cross section, schematically and partially, an exemplary embodiment of a security element according to the invention, comprising a non-reflecting optical structure,

FIGS. 2 and 3 illustrate, by front view, the observation of security elements as described in FIG. 1,

FIG. 4 represents, in transversal cross section, schematically and partially, another exemplary embodiment of a security element according to the invention, comprising a reflecting optical structure,

FIGS. 4A to 4C illustrate steps in the production of the reflecting optical structure of FIG. 4,

FIGS. 5 to 7 represent examples of objects comprising a security element according to the invention,

FIGS. 8 to 9 illustrate variant embodiments of reflecting optical structures,

FIG. 10 is a view similar to FIG. 9 of a variant embodiment,

FIG. 11 is a plan view according to X of FIG. 10,

FIG. 12 illustrates a mesh according to which certain reflecting structures can be arranged,

FIG. 13 represents an exemplary reflecting structure,

FIG. 14 represents an exemplary pattern that can be produced with the reflective structures of FIG. 13,

FIG. 15 represents another exemplary reflecting structure,

FIG. 16 represents the reflecting structure of FIG. 15, according to XV,

FIG. 17 represents another exemplary security element according to the invention,

FIG. 18 is a view according to XVII-XVII of FIG. 17,

FIGS. 19 and 20 respectively represent, by front view, the front and back of another exemplary security element according to the invention,

FIGS. 21 and 22 represent, respectively in cross section and by front view, another exemplary embodiment of a security element according to the invention, and

FIGS. 23 to 25 represent, in cross section, other exemplary embodiments of security elements according to the invention,

FIGS. 26 and 27 represent other exemplary embodiments of security elements according to the invention, and,

FIGS. 28 to 33 represent objects incorporating a security element according to exemplary implementations of the invention.

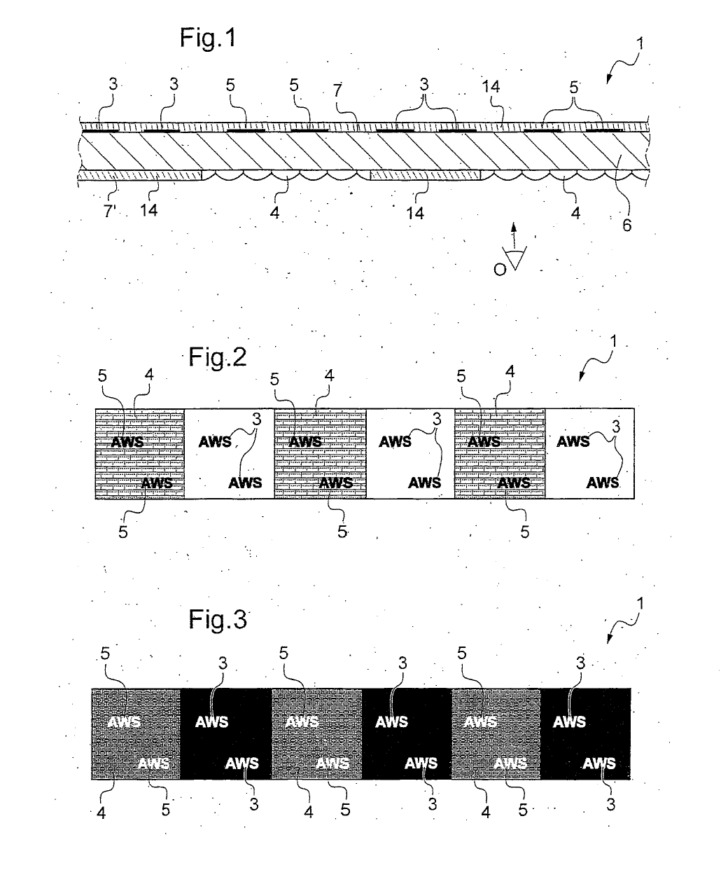

The security element 1 represented in FIG. 1 comprises a substrate 6, a front face 7 of which is covered by a number of reference patterns 3 and a number of comparison patterns 5, formed, for example, by microprinting, notably by a micro-lithography or copperplate engraving print technique. The comparison patterns 5 and the reference patterns 3 may, for example, be printed with a white ink or colored ink. The comparison patterns 5 and the reference patterns 3 may be as described previously, notably of the same size or not, of the same color or not, even of the same orientation or not.

The substrate 6 is, for example, a transparent film of synthetic material, for example a thermoplastic material, notably polyester.

The substrate 6 bears, on its back face 7′, a non-reflecting optical structure 4, consisting of a number of individual optical substructures. In the example of FIG. 1, these optical substructures are unconnected and are formed by individual optical structures such as lenses. These individual optical structures may be unconnected or not and/or identical or not.

The security element 1 may be covered on one or both of its external faces with an adhesive 14, notably a heat-sealable varnish. As illustrated in FIG. 1, the adhesive 14 may, for example, totally cover the front face 7 of the substrate 6 bearing the reference patterns 3 and the comparison patterns 5, and cover the back face 7′ of the substrate 6 only between the optical substructures of the optical structure 4, never covering the optical substructures so as not to damage their optical properties.

The adhesive may be transparent at least on the side of observation for example. In particular, the adhesive may be a heat-activatable adhesive, notably such as a heat-sealable coating or a heat-sealable varnish. Such adhesives are particularly advantageous when they are applied in procedures using high temperatures, notably with drying operations that are commonly used in the paper-making sector. Examples of adhesives, notably of heat-sealable varnishes, include an ultraviolet (UV) cross-linkable agent, an adhesive to be irradiated, a pressure-sensitive adhesive (PSA), a varnish with a solvent base, of polyester type for example, an adhesive in aqueous phase, etc. Adhesives in aqueous phase that can notably be cited are those known by the following brand names: Mowilith DC (aqueous dispersion of homopolymer vinyl acetate with particles of sizes ranging from 0.3 μm to 2 μm and with a glass transition temperature Tg of approximately 38° C., and dry solids content of between 55 and 57%) and Vinamul 3265 from the company CELANESE; DH9004, DH9017, DH9044 and DL5001 from the company COLLANO; Primal NW1 845, Primal LC40, Primal P308M and Primal EP6000 from the company ROHM & HAAS; 006SDW078-2 from the company BASF.

The adhesive 14 may make it possible to improve the adhesion of the security element 1 in an object in which it is intended to be inserted, notably a paper mass.

The reference patterns 3 correspond, for example, substantially to the images of the comparison patterns 5 by the optical structure 4. In this way, the authentication and/or identification of the security element 1 can be done by observing the back side 7′ of the substrate 6 bearing the optical structure 4.

FIGS. 2 and 3 illustrate, by front view, examples of observation of a security element 1 according to the invention, obtained, for example, from the security element 1 of FIG. 1.

FIG. 2 represents the observation of a security element 1 in which the comparison patterns 5 and the reference patterns 3 have been produced in positive, for example by metalization.

FIG. 3 illustrates an example of observation of a security element 1 according to the invention, in which the comparison patterns 5 and the reference patterns 3 have been produced in negative, for example by demetalization.

The observation of the images obtained from the comparison patterns 5 and the reference patterns 3 may make it possible to authenticate and/or identify the security element 1 by virtue of the observed visual similarity.

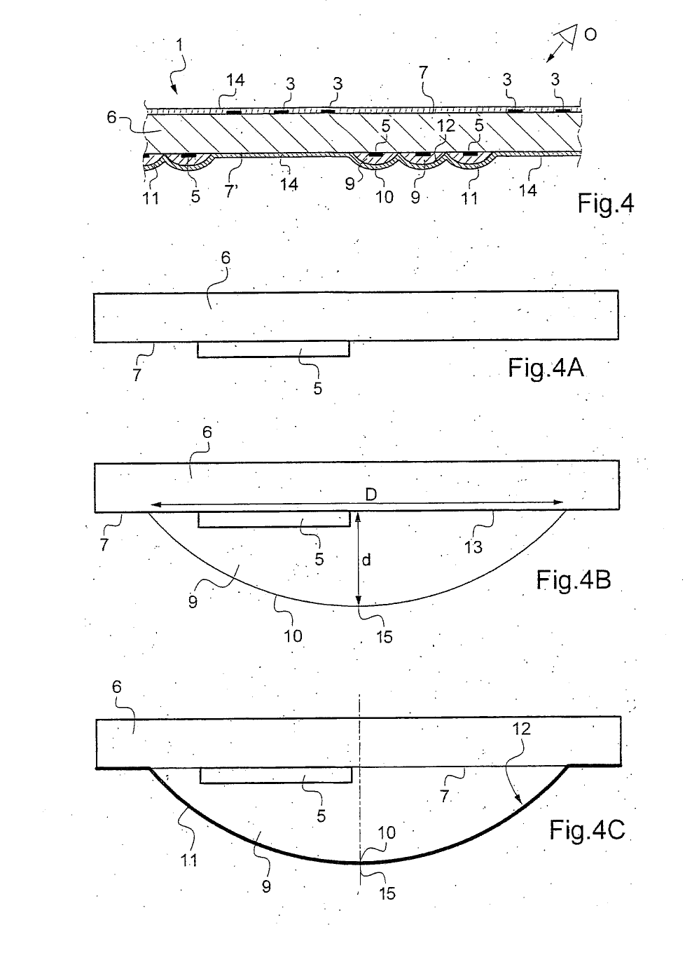

FIG. 4 shows another exemplary security element 1 according to the invention, comprising a reflecting optical structure 4.

The security element 1 comprises a substrate 6 bearing, for example on its front face 7, reference patterns 3, and on its back face 7′, comparison patterns 5, the optical structure 4 consisting of a number of optical substructures superposed on the comparison patterns 5.

At least one optical substructure, and notably the reflecting optical structure 4, may, for example, be in the form of an array of individual optical structures which are, in the example considered, lenses 9. A single lens 9 is represented in FIGS. 4B and 4C and these lenses 9 have a face 10, on the side opposite the substrate 6, which is non-planar, for example substantially in spherical skullcap form, as illustrated.

This face 10 may be covered with a reflecting coating 11, so as to form a non-planar mirror 12, forming a reflecting optical structure 4.

FIGS. 4A to 4C illustrate an exemplary embodiment of a reflecting optical structure 4 of a security element 1 conforming to FIG. 4, for example.

The method may begin with coating the substrate 6 with a comparison pattern 5, then, the lens array may be formed covering the comparison pattern 5, as illustrated in FIG. 4B. The formation of the lens array may be performed in a localized or non-localized manner relative to the comparison pattern 5.

The lenses 9 may, for example, be formed by a technique of printing, for example by flexography, inkjet, offset or screen printing, dots of ink of a transparent polymer ink which may be cross-linkable under UV.

The lenses 9 may also be produced by photogravure.

The formation of the lenses 9 may even be done by hot embossing of the substrate 6 with an etched metallic matrix in lens array form.

Then, the non-planar surface of the lens array is metalized, in order to form the mirrors, as illustrated in FIG. 4C. The metal is, for example, aluminum.

It can be seen in FIGS. 4B and 4C that a comparison pattern 5 may be situated in the concavity of the corresponding mirror.

In the example considered, the mirror 12 has a concave reflecting face and a distance d between the face 7 of the substrate 6 and the bottom 15 (also called “apex”) of the concavity of the mirror 12 is, for example, 15 μm, for a diameter D at the interface 13 with the substrate 6 of approximately 60 μm.

Thus, the radius of curvature of the mirror 12 may be approximately 37.5 μm and the focal distance of the mirror is then 18.8 μm. The result of this is that the mirror 12 supplies an enlarged image of the comparison pattern 5 to the observer O.

The comparison pattern 5 is, for example, a print 20 μm wide. The substrate 6 is, for example, 23 μm thick.

In the example of FIG. 4, a straight virtual image can be obtained that is larger than the comparison pattern 5, the latter being situated between the focus and the apex 15 of the concave mirror.

In another variant embodiment, the mirrors 12 are produced with a reflecting surface that is convex toward the comparison patterns, as illustrated in FIG. 8, which produces a smaller image of the comparison patterns.

Where appropriate, another optical device, for example an enlarging lens, for example of Fresnel lens type, may be associated with a reflecting mirror so as to once again enlarge the image produced by the mirror.

In another variant embodiment illustrated in FIG. 9, the image or images seen by the observer do not originate from a printed comparison pattern 5 but are formed by all the light dots created at the focal length of each mirror. The mirrors 12 may, as illustrated, be of different sizes to create light dots for example of different sizes or situated at different distances from the eye of the observer.

In this case, the comparison is made between the reference patterns 3 and the images formed by all the light dots created by the mirrors.

FIGS. 10 to 16 show variant embodiments in which at least one of the images seen by the observer is due to the way in which the light is reflected by a plurality of reflecting structures, of at least two different types.

In FIG. 10, it can be seen that the transparent substrate 6 may comprise, on one face, a plurality of reflecting surfaces 4a and 4b, of different respective forms or dimensions, covered by a layer 11, making it possible to create a reflecting surface, for example a layer of metal. The reflecting surfaces 4a are, for example, portions of a sphere as illustrated in FIGS. 15 and 16, with a height h of between, for example, 10 and 20 μm, for example of the order of 15 μm, and with a diameter A of between, for example, 20 and 40 μm, for example of the order of 30 μm.

The reflecting structures 4b are, for example, mirrors of pyramidal or truncated pyramid form, for example with a square base of side size Wₓ or W_{y} for example between 20 and 40 μm, for example of the order of 30 μm, the larger dimension Wₓ or W_{y} being, for example, equal to the diameter A at the reflecting base of the reflecting structures 4a.

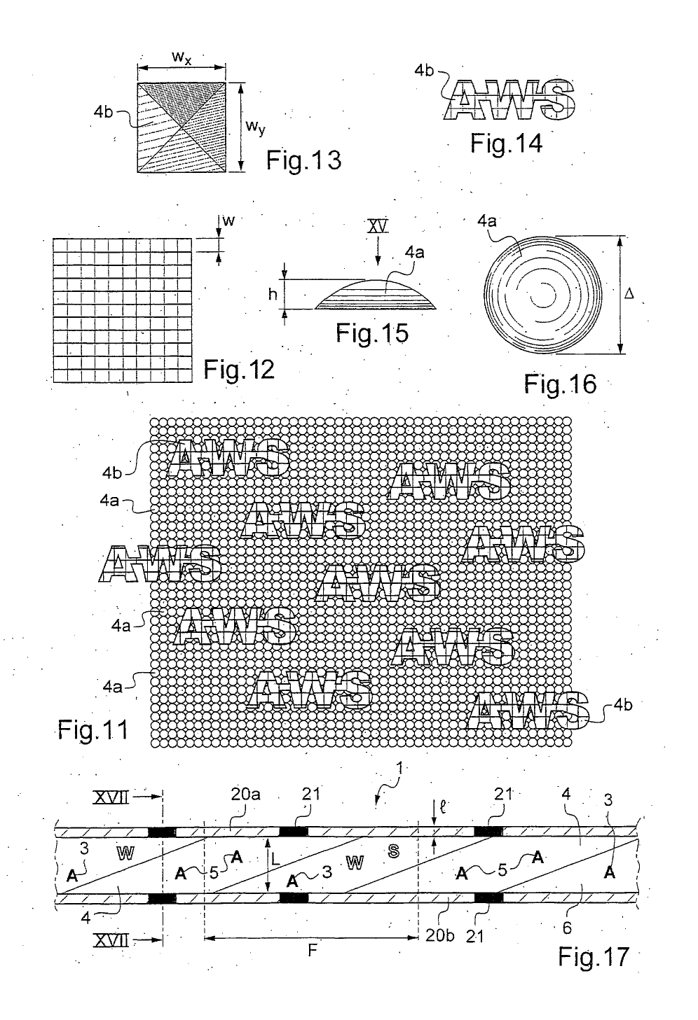

The reflecting structures 4b are, for example, arranged like the meshes of an array, as represented in FIG. 12, with a pitch W for example equal to Δ, for example of the order of 30 μm. The reflecting structures 4b may be arranged according to patterns, as illustrated in FIGS. 14 and 11. The reflecting structures 4a and 4b may be formed in various ways, for example by relief printing then metalization of these reliefs.

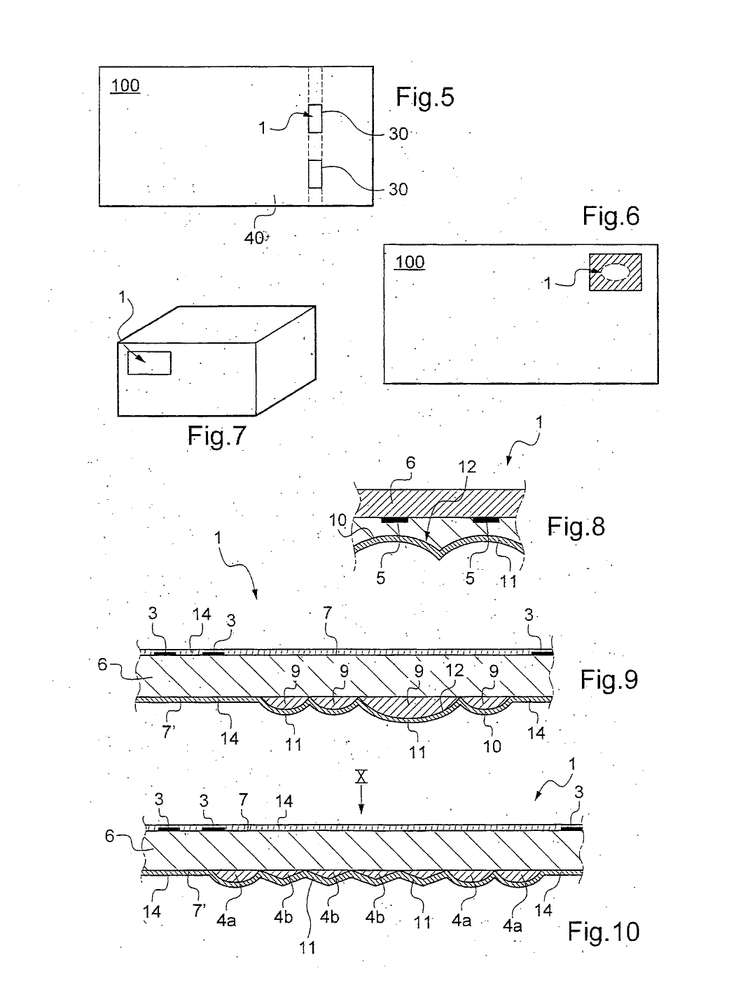

The security element 1 may take the form of a security thread, for example intended to be incorporated in windows in a paper 40, as illustrated in FIG. 5.

In this case, the security element 1 extends, for example, between two opposite edges of the paper. The security element may come to the surface of the paper by its external face situated on the side opposite the optical structure, at the level of a window 30.

As a variant, as illustrated in FIG. 6, the security element 1 is applied in patch form.

The security element 1 may also be incorporated in a package, as illustrated in FIG. 7, or in a label.

FIGS. 17 and 18 show another exemplary security element 1 according to the invention, in the form of a security thread.

The security element 1 comprises a substrate 6 on the back side 7′ of which are reference patterns 3, produced, for example, in positive by demetalization.

The security element 1 also comprises comparison patterns 5, formed, for example, by printing on the substrate 6, of suitable dimension because they are seen through the optical structure, and arranged alternately in the longitudinal direction with the reference patterns 3.

The security element 1 also comprises an optical structure 4 consisting of a number of optical substructures each comprising individual optical structures and covering the comparison patterns 5.

The optical substructures are, for example, in the form of parallelograms, whose large side is non-perpendicular to the length of the security element 1, as represented in FIG. 17.

The security element 1 may be incorporated or not in window(s) in a security document.

In an incorporation in window(s), the window F may, for example, be produced so as to be able to observe at least a part of a comparison pattern and a part of a reference pattern, as can be seen in FIG. 17.

The security element 1 also comprises, at its edges, two continuous metalized edge areas 20a and 20b, also comprising magnetic elements 21. In this way, the security element may have electrical conductivity properties and magnetic properties.

The width l of the metalized edge areas 20a and 20b is, for example, between 1 and 2 mm, for example equal to 1.5 mm.

The width L of the central area of the security element bearing the reference patterns 3, the comparison patterns 5 and the optical structure 4, is, for example, between 3 and 4 mm.

The security element 1 may comprise a substrate 6 made of PET, with a thickness, for example, equal to 23 mm.

The optical structure 4 may comprise an array of individual optical structures which are, for example, lenses having a thickness of 6 μm and a diameter equal to 20 μm.

The security element 1 may also be covered with an adhesive 14, notably a heat-sealable varnish, for example over all of the back face 7′ of the substrate 6 opposite the optical structure 4, as can be seen in FIG. 18, and only outside the optical structure 4 on the front face 7 of the substrate 6.

The thickness of the adhesive is, for example, between 3 and 4 μm. The magnetic elements 21 may be printed on the metalized areas 20a and 20b, or, as a variant, on the surface of the substrate 6, then covered by the metalized areas 20a and 20b.

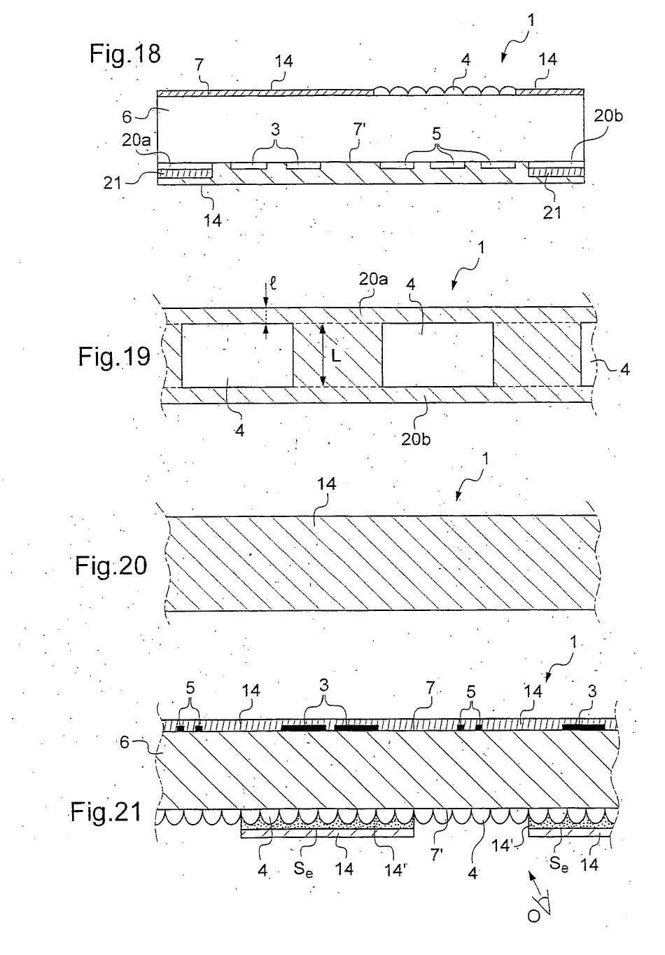

FIGS. 19 and 20 represent respectively, by front view, the front and the back of another exemplary security element 1 according to the invention.

In this example, the security element 1 comprises, on its front, an optical structure 4 consisting of a number of optical substructures, notably of rectangular form, the large side of which is parallel to the large side of the security element 1. The substrate 6 may bear, between the optical substructures, one or more reference patterns (not represented).

The optical structure 4 does not extend from one edge to the other of the security element 1 according to its width. This way, the security element 1 has two edge areas 20a and 20b.

The edge areas 20a and 20b are, for example, covered with an adhesive 14. The adhesive 14 may also be applied between the optical substructures, as represented in FIG. 19.

The edge areas 20a and 20b may or may not comprise one or more security elements as described above.

On the back side, as represented in FIG. 20, the security element 1 may be entirely covered with an adhesive 14.

The substrate 6 of the security element 1 may or may not comprise one or more comparison patterns (not represented) so that the optical structure is superposed on the comparison pattern(s). The comparison pattern(s) may be borne by the front and/or back face of the substrate 6 of the security element 1.

The width l of the edge areas 20a and 20b is, for example, between 1 and 2 mm, for example equal to 1.5 mm.

The width L of the central area of the security element 1 bearing the optical structure 4, is, for example, between 3 and 4 mm.

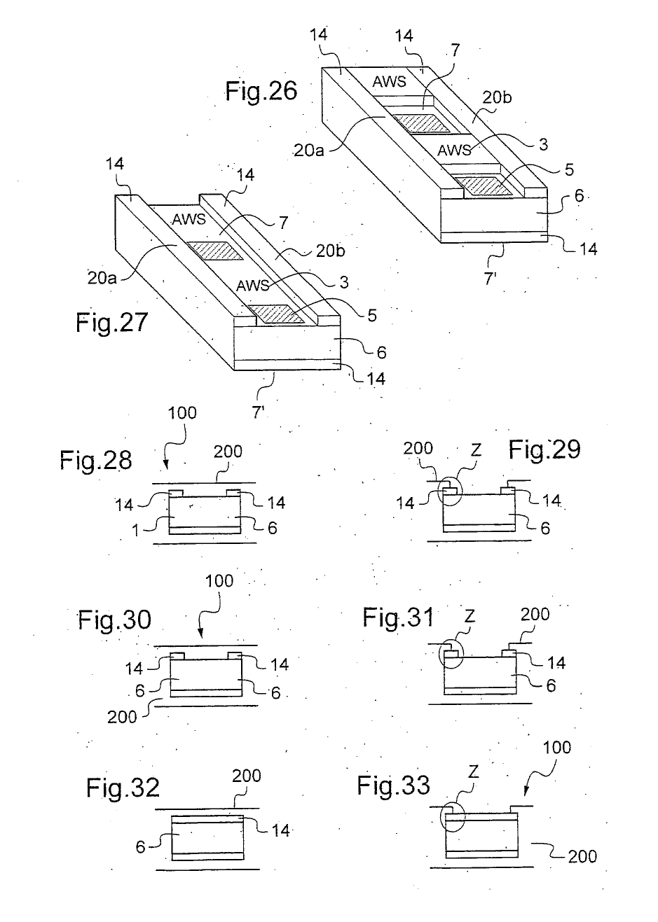

FIGS. 26 and 27 represent another exemplary security element in which the edge areas 20a and 20b are covered with adhesive.

In the example of FIG. 26, adhesive bridges extend over the face 7 of the substrate, for example in the places on the face 7 where the reference patterns 3 are arranged. These reference patterns 3 may then be able to be observed through the adhesive bridges.

In the example of FIG. 27, the face 7 of the substrate 6 is covered with adhesive 14 only at the edge areas 20a and 20b.

As can be seen in FIGS. 26 and 27, the adhesive 14 may be arranged on the edge areas over the entire length of the thread.

FIGS. 28 to 33 represent, in cross section and schematically, an object 100 in which a security element 1 according to FIG. 26 or 27 is incorporated.

In the example of FIGS. 29, 31 and 33, the security element 1 is incorporated in a window formed in a fibrous base 200 of the object 100. The edges of this window form an area of overlap Z between the fibrous base 200 and the adhesive 14. This area of overlap may extend all along the window and then make it possible to link the fibers of the fibrous base 200 to the security element over the entire length of the window.

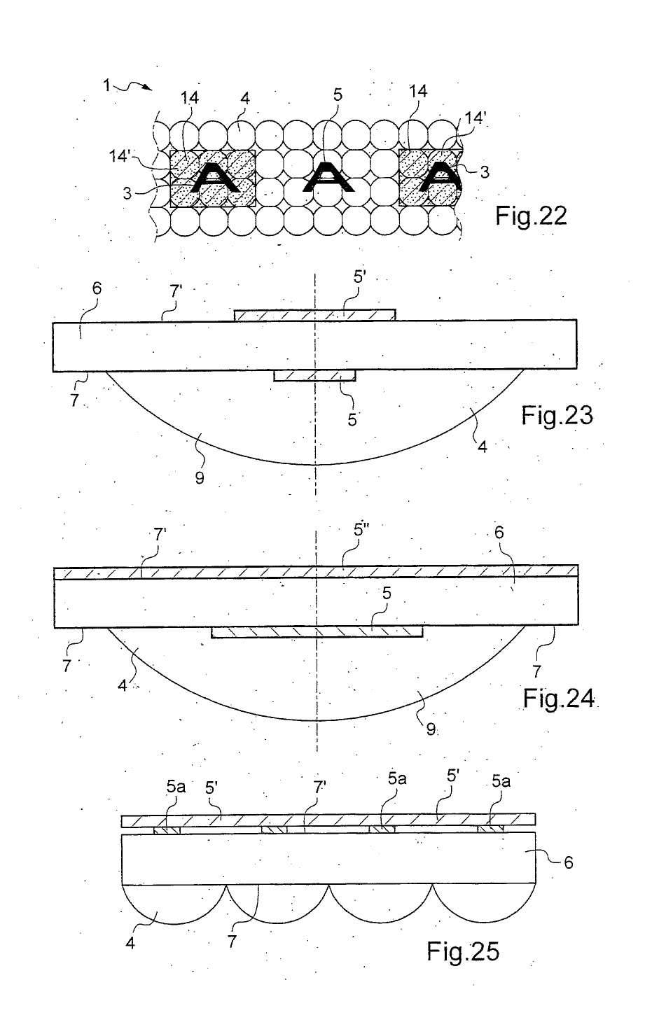

FIGS. 21 and 22 show, respectively in cross section and by front view, another exemplary security element 1 according to the invention.

In this example, the security element 1 comprises a substrate 6 on a face 7′ of which there is an optical structure 4 totally covering said face 7′. The optical structure 4 is formed by non-unconnected optical substructures.

The face 7, opposite the face 7′ bearing the optical structure 4, bears reference patterns 3 and comparison patterns 5.

The optical structure 4 is partially covered by an inactivation varnish 14′ which is superposed on the reference patterns 3.

The inactivation varnish 14′ is advantageously a varnish canceling the optical effect(s) of the optical structure 4. The observation of the reference patterns 3 through the optical structure 4 covered with the inactivation varnish 14′ corresponds to the direct observation that would be made of the reference patterns 3 without the presence of the optical structure 4. In this way, the optical structure 4 retains its optical effects only in the areas not covered by the inactivation varnish 14′, notably the areas superposed on the comparison patterns 5.

The inactivation varnish 14′ may be chosen so as to have a refractive index that makes it possible to cancel the optical effects obtained by the optical structure 4. The refractive index of the inactivation varnish 14′ may, for example, be the same as that of the optical structure, notably of the area of the optical structure 4 on which the inactivation varnish 14′ is applied.

The external surface Sₑ of the inactivation varnish 14′ is advantageously planar.

In FIG. 22, the image of the comparison pattern 5 represented corresponds, for example, to an enlargement of the comparison pattern 5 borne by the substrate 6 by virtue of the observation through the optical structure 4. The reference pattern 3, on the other hand, is represented on a 1:1 scale and may, for example, have the dimensions of the reference pattern 3 after enlargement. In practice, the observation through the optical structure 4 of the reference pattern 3 does not produce any effect, notably no enlargement, of this pattern because of the cancellation of the optical effects by the inactivation varnish 14′.

Also in this example, the face 7 of the substrate 6 is totally covered with an adhesive 14, notably a heat-sealable varnish. The adhesive 14 is also applied to the inactivation varnish 14′ covering the optical structure 4 borne by the face 7′ of the substrate 6.

The presence of the adhesive 14 on the face 7′ of the substrate 6 covering only the areas of the optical structure 4 covered with the inactivation varnish 14′ may make it possible not to damage the optical properties of observation of the optical structure 4 in the areas not covered by the inactivation varnish 14′, notably the areas of the optical structure 4 superposed on the comparison patterns 5.

As a variant, the adhesive 14 could be an inactivation varnish and, therefore, the inactivation varnish 14′ could be omitted, the optical structure 4 being partially covered only with the adhesive 14 having an inactivation nature with regard to the optical effects of the optical structure 4.

FIGS. 23 to 25 show, schematically and partially, other exemplary embodiments of security elements 1 according to the invention.

In the example of FIG. 23, the substrate 6 bears on its face 7 a comparison pattern 5, and on its face 7′ a secondary comparison pattern 5′. As described previously, the respective images of the comparison patterns 5 and 5′ thus appear to the eye of the observer at different distances thus creating an effect of volume and of depth.

In the example of FIG. 24, the substrate 6 bears, on one of its faces 7, a comparison pattern 5 and, on the other of its faces 7′, an additional pattern 5′.

The comparison pattern 5 and the additional pattern 5″ created in this way may make it possible to be able to observe at least one of the images of the comparison pattern through the optical structure 4 and the additional pattern 5″ not affected by the optical structure in different planes. The additional pattern 5″ is not affected by the optical structure, for example by virtue of its distance from the optical structure and/or by virtue of its large dimension relative to the individual optical structure or not. In particular, the additional pattern 5″, although placed in a plane more distant from the observer than the comparison pattern 5, may appear in the foreground.

In the example of FIG. 25, the substrate 6 bears, on its face 7, a comparison pattern 5 consisting of a number of individual comparison patterns 5a.

An additional pattern 5″ is formed on the comparison pattern 5 and has dimensions greater than the individual comparison patterns 5a such that only the observation of the individual comparison patterns 5a is affected by the optical structure 4. The additional pattern 5″ may appear as a background on which is observed the image, through the optical structure 4, of the individual comparison patterns 5a. In the same way as previously, at least one of the images through the optical structure 4 of the individual comparison patterns 5a and the additional pattern 5″ appear in different planes.

The expression “comprising a” should be understood to be synonymous with “comprising at least one”, unless specified otherwise.

1. A security element comprising a substrate bearing, on at least one of its faces, at least:
one optical structure producing at least one image of at least one pattern and/or producing image points of a light source illuminating the optical structure,
an adhesive at least partially covering said face of the substrate without completely covering the optical structure,
the security element being a security thread, and the optical structure extending only partially over the width of the security thread so that the substrate of the security thread has at least one edge area not covered by the optical structure.

2. The security element as claimed in claim 1, being a security thread having a width greater than or equal to 4 mm.

3. The security element as claimed in claim 1, the optical structure only partially covering said face of the substrate.

4. The security element as claimed in claim 3, the adhesive totally covering the area or areas of said face of the substrate not covered by the optical structure.

5. The security element as claimed in claim 1, the optical structure not extending from one edge to the other of the substrate depending on the length and/or the width of the substrate.

6. The security element as claimed in claim 1, the optical structure being discontinuous, consisting of a set of unconnected optical substructures, and the adhesive covering, the area or areas of said face of the substrate not covered by the optical substructures.

7. The security element as claimed in claim 1, said at least one edge area being covered by the adhesive.

8. The security element as claimed in claim 1, said at least one edge area comprising at least one magnetic element.

9. The security element as claimed in claim 1, said at least one edge area having a width of between 0.5 and 2 mm.

10. The security element as claimed in claim 1, comprising two edge areas spaced apart by a distance of between 2 and 9 mm.

11. The security element as claimed in claim 1, the optical structure comprising a lens array.

12. The security element as claimed in claim 1, the optical structure being reflecting.

13. The security element as claimed in claim 1, the optical structure having a non-planar external surface.

14. The security element as claimed in claim 1, the optical structure being partially covered by at least one inactivation varnish canceling the optical effect or effects obtained by the optical structure.

15. The security element as claimed in claim 14, the inactivation varnish being superposed on one or more reference patterns borne by the substrate, the face of the substrate opposite the face bearing the optical structure.

16. An object incorporating a security element as claimed in claim 1.

17. The object as claimed in claim 20, the security element being incorporated in window(s) in the object so as to be able to observe at least partially the optical structure in at least one window.

18. The object as claimed in claim 20, the security element not extending from one edge to the other of the object.

19. The security element as claimed in claim 15, the one or more reference patterns being borne by the face of the substrate opposite the face bearing the optical structure.

20. The object of claim 17, being a security document.
